(19) United States
(12) Patent Application Publication
(10) Pub. No.: US 2025/0373474 A1
(43) Pub. Date: Dec. 4, 2025

(54) PROCESSING OF NARROW BAND-INTERNET OF THINGS (NB-IoT) PHYSICAL RESOURCE BLOCK (PRB)

(71) Applicant: RAKUTEN SYMPHONY, INC., Tokyo (JP)

(72) Inventors: Rajesh Girmalla TELI, Tokyo (JP); Aghil Vinayak PUZHAKKAL, Tokyo (JP)

(73) Assignee: RAKUTEN SYMPHONY, INC., Tokyo (JP)

(21) Appl. No.: 18/904,175

(22) Filed: Oct. 2, 2024

(30) Foreign Application Priority Data
May 30, 2024 (IN) 202441042138

(51) Int. Cl. H04L 27/00; H04W 4/70

(52) U.S. Cl. CPC H04L 27/0014; H04W 4/70; H04L 2027/0026

(57) ABSTRACT

Embodiments of the present disclosure disclose processing of Narrow Band-Internet of Things (NB-IoT) Physical Resource Block (PRB). The method comprises aligning center of Physical Resource Block (PRB) in received time domain samples of Long-Term Evolution (LTE) channel bandwidth to center of LTE channel bandwidth; upon aligning center of PRB with center of LTE channel bandwidth, performing decimation on received time domain samples at predefined number of decimation stages sequentially to obtain decimated time domain samples of predefined sample rate; performing Fast Fourier Transform (FFT) operation on decimated time domain samples using FFT of predefined point to obtain corresponding frequency domain samples related to decimated time domain samples; and extracting valid tones from frequency domain samples based on valid tone indices to obtain modified PRB. The modified PRB is transmitted to processing unit for decoding data from modified PRB.

### CROSS-REFERENCE TO RELATED APPLICATION(S)

This application claims priority based on India Non-Provisional Patent Application No. 202441042138, filed May 30, 2024.

### FIELD

The present disclosure relates to processing of Narrow Band-Internet of Things (NB-IoT) Physical Resource Block (PRB).

### BACKGROUND

Narrow Band-Internet of Things (NB-IoT) is a wireless communication technology based on lower power wireless defining a physical layer and a protocol stack supporting various IoT devices and applications. NB-IoT operates on multiple frequency bands, suitable for extended coverage, power device complexity and higher data rates. It incorporates technologies such as transmission repetitions, various bandwidth allocation strategies and configurations for uplink transmissions and dynamic spectrum sharing to enhance performance and efficiency of the communication network. In addition to the above, NB-IoT supports reduced power consumption of the connected IoT devices while leveraging the above-stated techniques to enhance overall system capacity with wider coverage.

NB-IoT includes a Narrowband Physical Uplink Shared Channel (NPUSCH) for transmitting uplink user data and control information from a User Equipment (UE) to a Base Station (BS). In NB IoT communication network, examples of the UE may include, but are not limited to, parking sensors, smart power meters, pet tracking sensors, motion sensors, etc. Precisely, in the NB-IoT applications, NPUSCH supports two transmission formats NPUSCH Format-1 and NPUSCH Format-2. NPUSCH Format-1 is used for carrying uplink data and NPUSCH Format-2 is intended to transmit UE's Uplink Control data to the base station. For example, NPUSCH Format-2 may be used for signaling acknowledgement information, such as HARQ Ack, for Narrowband Physical Downlink Shared Channel (NPDSCH). NPUSCH Format-2 may use repetition code for error correction and may include a plurality of symbols per slot including a subset of symbols used as DeModulation Reference Signal (DMRS) and another subset of data symbols.

However, in the NB-IoT applications, there may be scenarios in which the UE from which signals are to be obtained are placed at such location from where it is difficult for the base station to detect the signals with low signal-to-noise ratio (SNR). For example, equipment/sensors, such as parking sensors which are placed in basements, etc. from which uplink signals are to be obtained by the base station. In such scenarios, existing methods of channel estimation to separate the noise/interference from Uplink signal are not sufficient. In addition, they cater to additional problems including failure to consider Carrier Frequency Offset (CFO) estimates obtained for previous NPUSCH blocks, associated with Previous Resource Units (RUs), causing accuracy issues in the channel estimation. Therefore, when the CFO and TO estimates of the previous NPUSCH block are not considered for the channel estimation, overall channel estimate accuracy is low at lower SNRs. In other words, Mean Squared Error (MSE) for channel estimates is high at the lower SNRs. Moreover, Signal to Interference plus Noise Ratio (SINR) threshold for Discontinuous Transmission (DTX) detection and the CFO/TO estimation are not based on interference level which can dynamically change across cells. In this case as well, the MSE for the channel estimates are high at the lower SNRs. Thus, the channel estimation accuracy reduces. Also, the existing methods consume more hardware resources at the front end i.e., Field Programmable Gate Arrays (FPGA) as Fast Fourier Transform (FFT) of higher point is used.

The information disclosed in this background section is only for enhancement of understanding of the general background of the disclosure and should not be taken as an acknowledgement or any form of suggestion that this information forms the prior art already known to a person skilled in the art.

### SUMMARY

In an embodiment, the present disclosure discloses a method. The method comprises aligning a center of a Physical Resource Block (PRB) in a received time domain samples of Long-Term Evolution (LTE) channel bandwidth to a center of the LTE channel bandwidth. Upon aligning the center of the PRB with the center of the LTE channel bandwidth, the method comprises performing decimation on the received time domain samples at a predefined number of decimation stages sequentially to obtain a decimated time domain samples of a predefined sample rate. Thereafter, the method comprises performing Fast Fourier Transform (FFT) operation on the decimated time domain samples using the FFT of the predefined point to obtain corresponding frequency domain samples related to the decimated time domain samples. Finally, the method comprises extracting valid tones from the frequency domain samples based on valid tone indices to obtain a modified PRB. The modified PRB is transmitted to a processing unit for decoding data from the modified PRB.

In an embodiment, the present disclosure discloses a base station. The base station is configured to align a center of a Physical Resource Block (PRB) in a received time domain samples of Long-Term Evolution (LTE) channel bandwidth to a center of the LTE channel bandwidth. Upon aligning the center of the PRB with the center of the LTE channel bandwidth, the base station is configured to perform decimation on the received time domain samples at a predefined number of decimation stages sequentially to obtain a decimated time domain samples of a predefined sample rate. Thereafter, the base station is configured to perform Fast Fourier Transform (FFT) operation on the decimated time domain samples using the FFT of the predefined point to obtain corresponding frequency domain samples related to the decimated time domain samples. Finally, the base station is configured to extract valid tones from the frequency domain samples based on valid tone indices to obtain a modified PRB. The modified PRB is transmitted to a processing unit for decoding data from the modified PRB.

In an embodiment, the present disclosure discloses a non-transitory computer readable medium including instructions stored thereon that when processed by at least one processor, cause the at least one processor to perform operations of aligning a center of a Physical Resource Block (PRB) in a received time domain samples of Long-Term Evolution (LTE) channel bandwidth to a center of the LTE channel bandwidth. Upon aligning the center of the PRB with the center of the LTE channel bandwidth, the processor performs decimation on the received time domain samples at a predefined number of decimation stages sequentially to obtain a decimated time domain samples of a predefined sample rate. Thereafter, the processor performs Fast Fourier Transform (FFT) operation on the decimated time domain samples using the FFT of the predefined point to obtain corresponding frequency domain samples related to the decimated time domain samples. Finally, the processor extracts valid tones from the frequency domain samples based on valid tone indices to obtain a modified PRB. The modified PRB is transmitted to a processing unit for decoding data from the modified PRB.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1A illustrates an exemplary architecture illustrating disaggregated base station, in accordance with some embodiments of the present disclosure;

FIG. 1B shows exemplary stages of decimation performed on the time domain samples, in accordance with some embodiments of the present disclosure;

FIG. 1C shows an exemplary flowchart illustrating method steps for performing block processing, in accordance with some embodiments of the present disclosure;

FIG. 2 illustrates a detailed block diagram of a base station, in accordance with some embodiments of the present disclosure;

FIG. 3 illustrates exemplary flowchart illustrating method steps for processing of an exemplary Physical Resource Block (PRB) i.e., a Narrow Band-Internet of Things (NB-IoT) PRB, in accordance with some embodiments of the present disclosure;

FIG. 4 shows a diagram of example components of a base station for processing of Narrow Band-Internet of Things (NB-IoT) Physical Resource Block (PRB), in accordance with embodiments of the present disclosure.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

As discussed in the background section, in the NB-IoT applications, there may be scenarios in which the User Equipment (UE) from which signals are to be obtained are placed at such location from where it is difficult for the base station to detect the signals with low Signal-To-Noise Ratio (SNR). Also, the existing methods consume more hardware resources at the front end i.e., Field Programmable Gate Arrays (FPGA) as Fast Fourier Transform (FFT) of higher point is used. As an example, FFT of size 8192 point is used. For 8192 FFT memory requirement and CPU compute cycle requirement will be high. As an example, to support 3.75 kHz subcarrier spacing with baseband rate of 30.72 Msps, 8192-point FFT is required. Further, the existing methods require more memory and more compute cycles to process four times more samples in time/frequency domain. Moreover, Signal to Interference plus Noise Ratio (SINR) threshold for Discontinuous Transmission (DTX) detection and the CFO/TO estimation are not based on interference level which can dynamically change across cells. Therefore, to overcome, the existing problems, the present disclosure provides methods and apparatuses to process Narrow Band-Internet of Things (NB-IoT). According to the present disclosure, the base station aligns a center of a Physical Resource Block (PRB) in a received time domain samples of Long-Term Evolution (LTE) channel bandwidth to a center of the LTE channel bandwidth. As an example, the PRB is an NB-IoT PRB. The received time domain samples may be of a very high sampling rate. Upon aligning the PRB, the base station may perform decimation on the received time domain samples at a predefined number of decimation stages sequentially to obtain a decimated time domain samples of a predefined sample rate. The decimation stages may be determined based on a predefined decimation factor. As an example, decimation factor of sixteen may have four decimation stages. Thereafter, the base station performs Fast Fourier Transform (FFT) operation on the decimated time domain samples using the FFT of the predefined point to obtain corresponding frequency domain samples related to the decimated time domain samples. Finally, the base station extracts valid tones to obtain a modified PRB from the frequency domain samples based on valid tone indices. As an example, the modified PRB is an NB-IoT PRB. The modified PRB is transmitted to a processing unit for decoding data from the modified PRB. According to the present disclosure, FFT of size 512 point can be used without performance degradation which will consume ¼ of hardware resources. By applying decimation to time domain samples, we can reduce number of input samples to FFT module. Hardware complexity of decimation factor 16 is further reduced by implementing decimation in four stages (each of decimation factor 2) and bringing decimation filter taps to 19. Noise and interference estimation is using proprietary algorithm. With accurate noise and interference estimation, SINR thresholds can be used for DTX detection and CFO/TO estimation.

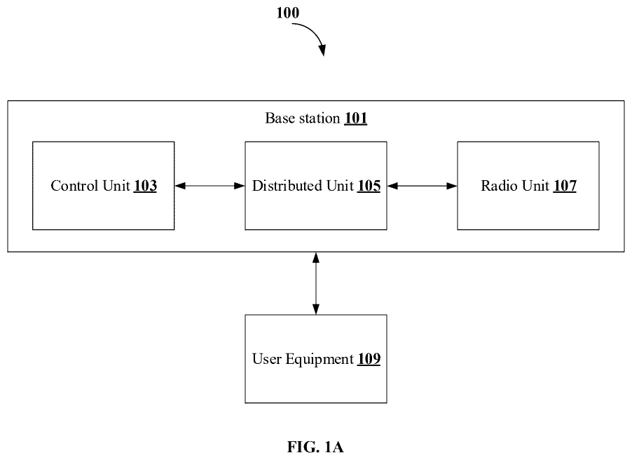

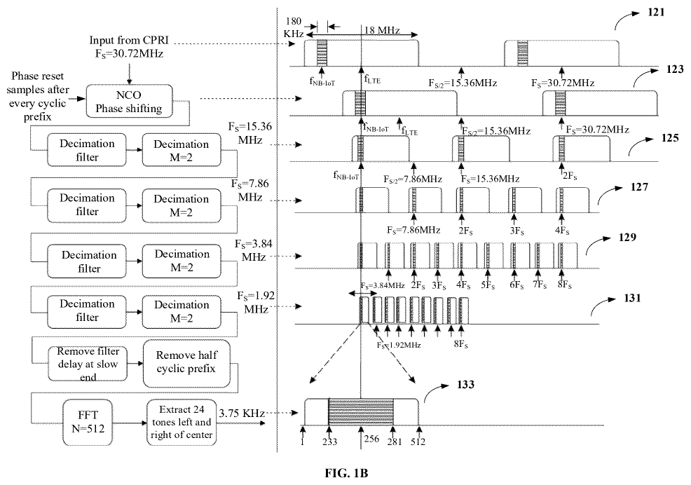

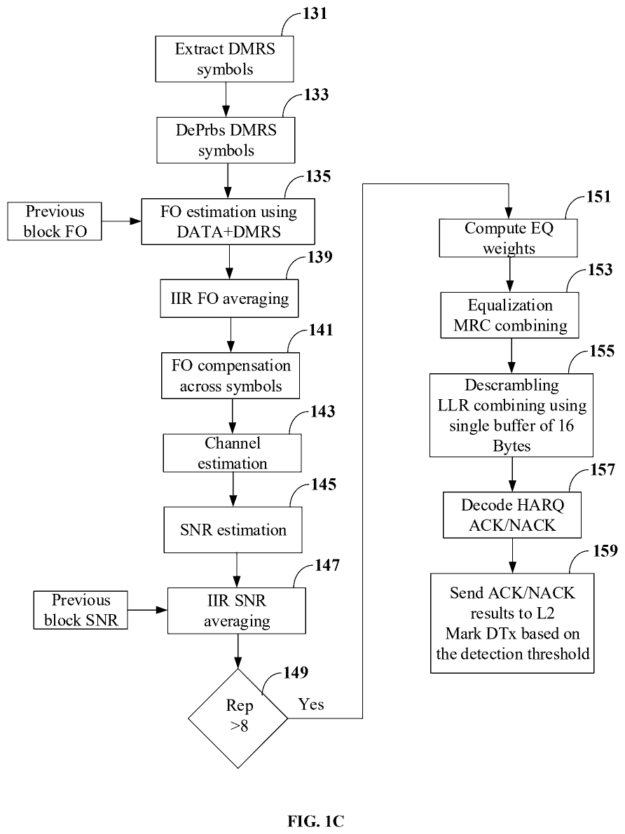

FIG. 1A shows an exemplary architecture illustrating disaggregated base station, in accordance with some embodiments of the present disclosure.

In Fifth Generation (5G) networks, a base station 101 is split into three distinct components i.e., a Centralized Unit (CU) 103, a Distributed Unit (DU) 105, and a radio unit 107. The CU 103 serves as central intelligence, adeptly handling complex and centralized network functions. These functions include, but are not limited to, proficient radio resource management, effective network control, and seamless coordination with the 5GC. The DU 105 is responsible for managing data plane processing, encompassing vital tasks such as data transmission and reception with a User Equipment (UE) 109. The DU 105 interfaces seamlessly with the CU 103 over F1 interface. The description of the present disclosure is explained considering Fifth Generation (5G) networks only. However, the present disclosure is applicable to any type of networks such as Fourth Generation (4G) networks, 6G networks, and the like.

Exemplary architecture 100 illustrates component DU 105 of the base station 101 connected to components CU 103 and radio unit 107. In an embodiment, the DU 105 may include, without limitation, DU transmitter and DU receiver (not shown in figure). As an example, the DU receiver may be a 3.75 Kilo Hertz (KHz) sub-carrier spacing. In an embodiment, the radio unit 107 may include, without limitation, Narrowband Physical Uplink Shared Channel (NPUSCH) Field Programmable Gate Arrays (FPGA) module and a Remote Radio Head (RRH). As an example, the NPUSCH FPGA module may be a 3.75 KHz module. Further, plurality of UEs 109 may communicate with the base station 101 to transmit and receive information via the telecommunication network. The plurality of UEs 109 mentioned in present disclosure are associated with Internet of Things (IoT) devices. As an example, the plurality of UEs 109 may include, without limitation, parking sensors, smart power meters, pet tracking sensors and motion sensors.

In an embodiment, the base station 101 may be configured to align a center of a Physical Resource Block (PRB) in a received time domain samples of Long-Term Evolution (LTE) channel bandwidth to a center of the LTE channel bandwidth. In an embodiment, the PRB may be a Narrow Band-Internet of Things (NB-IoT) PRB. In an embodiment, the plurality of UEs may transmit the plurality of uplink signals utilizing an NPUSCH Format 1/Format 2. As an example, the signal may be received using Common Public Radio Interface (CPRI). In an embodiment, to align the PRB, the base station 101 may determine a phase ramp of the received time domain samples. The phase value is a difference between the center of the LTE bandwidth and the center of the PRB. As an example, the Numerically-Controlled Oscillator (NCO) of the radio unit 107 may determine the phase ramp. Upon determining the phase ramp, the base station 101 may shift the center of the PRB by the determined phase ramp to align PRB to the center of the LTE channel bandwidth. As shown in FIG. 1B, at step 121, time domain samples of LTE channel with the NB-IoT PRB is received. At step 123, the center of the PRB is aligned with the center of the predefined point of the FFT.

In an embodiment, upon aligning the center of the PRB to the center of the LTE channel bandwidth, the base station 101 may be configured to perform decimation on the received time domain samples at a predefined number of decimation stages sequentially to obtain decimated time domain samples of a predefined sample rate. In an embodiment, the predefined number of decimation stages are determined based on a predefined decimation factor. In an embodiment, the base station 101 may perform decimation filtering on the received time domain samples to obtain filtered time domain samples prior to performing decimation at each of the predefined number of decimation stages. Upon performing decimation filtering, the base station 101 may perform decimation on the filtered time domain samples to obtain the decimated time domain samples. The decimated time domain samples at each decimation stage of the predefined number of decimation stages is used in subsequent decimation stages.

Referring to FIG. 1B, upon aligning the PRB to the center of the LTE channel bandwidth, the base station 101 may perform decimation on the received time domain samples at four stages. The four stages are determined based on the decimation factor which in this case is sixteen. At each stage, the decimation by a factor of two is performed. Considering an exemplary value of 30.72 Mega Hertz (MHz) time domain samples is received, upon aligning the center of the PRB, the decimation filtering is performed followed by decimation by factor of two. In this exemplary scenario, the decimated value of the time domain samples after first stage of decimation is 15.36 MHz. Further, on the decimated time domain samples of 15.36 MHz, decimation filtering and decimation is performed in the second stage. The decimated value of the time domain samples after second stage of decimation is 7.68 MHz. Thereafter, on the decimated time domain samples of 7.68 MHz, decimation filtering and decimation is performed in the third stage. The decimated value of the time domain samples after third stage of decimation is 3.84 MHz. Finally, on the decimated time domain samples of 3.84 MHz, decimation filtering and decimation is performed in the fourth stage. The decimated value of the time domain samples after fourth stage of decimation is 1.92 MHz. Therefore, the value of the final decimated time domain samples is 1.92 MHz.

In some embodiments, upon performing the decimation, the base station 101 may be configured to perform Fast Fourier Transform (FFT) operation on the decimated time domain samples using the FFT of the predefined point to obtain corresponding frequency domain samples related to the decimated time domain samples. As an example, 512-point FFT may be used to perform FFT operation. In an embodiment, prior to performing FFT operation, the base station 101 may remove filter delay at slow end in the decimated time domain samples. In an embodiment, during decimation filtering, group delay is introduced at each of the decimation stages. After performing four stages of decimation, extra delay introduced by this step is nullified by removing eight samples at the end of decimation. Above calculation specifies filter group delay at each stage of decimation. The group delay of a filter is a measure of the average time delay of the filter as a function of frequency. Further, cyclic prefix is also removed. The cyclic prefix is added prior to performing phase shift of the PRB. As an example, half cyclic prefix may be removed when decimation is performed on the decimated time domain samples. Thereafter, the base station 101 may perform the FFT operation. In an embodiment, subcarrier spacing of the decimated time domain samples of 1.92 MZ is 3.75 KHz.

In an embodiment, upon performing the FFT operation, the base station 101 may be configured to extract valid tones from the frequency domain samples based on valid tone indices to obtain a modified PRB. In some embodiments, the extracted valid tones may be referred as a modified PRB in the context of the present disclosure. The modified PRB is transmitted to a processing unit for decoding data from the modified PRB. In an embodiment, the base station 101 may extract a predefined number of tones from left and right of the center of the frequency domain sample to obtain the valid tones within the frequency domain samples. As the PRB is aligned in the center, the predefined number of tones from left and right are extracted. Referring to FIG. 1B, twenty four tones each in both the directions i.e., left and right from the center are extracted by the base station 101. Specifically, 24 tones left of center i.e., 256 point is 233 point and 24 tones right of center i.e., 256 point is 281 point. This is an exemplary scenario for 512-point FFT. As an example, the extracted valid tones may be transmitted to a block processing unit in DU which decodes the data from the PRB. The data may be user data and control data.

In an embodiment, the block processing may be performed upon performing the steps discussed above. In some embodiments, the block processing may also be performed without performing the steps discussed above. In an embodiment, the base station 101 may receive one or more Resource Unit (RU) blocks from a Radio Unit. The one or more RU blocks are associated with the modified PRB. The RU specifies number of slots present at a given time. As an example, the number of slots as per NPUSCH Format 1 for frequency of 3.75 KHz is 16 slots and as per Format 2 is 4 slots. In an embodiment, one or more RUs may for a resource block. As an example, two RUs may form one resource block. The resource block indicates NB-IoT frequency domain allocation. Further, the base station 101 may determine a final Frequency Offset (FO) and a final Signal to Interference Noise Ratio (SINR) of each of the one or more RU blocks by recursively performing weighted moving average FO of each of the RU blocks with FO of corresponding previous RU block, and SINR of each of the RUs with SINR of corresponding previous RU block. Finally, the base station 101 may decode the data from each of the one or more RU blocks using the final FO and the final SINR. The detailed steps associated with block processing are illustrated in FIG. 1C.

FIG. 1B shows exemplary stages of decimation performed on the time domain samples, in accordance with some embodiments of the present disclosure.

At step 121, time domain samples of LTE channel with the NB-IoT PRB is received. At step 123, the center of the PRB is aligned with the center of the predefined point of the FFT. At step 125, decimation filtering is performed upon aligning the center of the NB-IoT PRB. Considering an exemplary value of 30.72 Mega Hertz (MHz) time domain samples is received, upon aligning the center of the PRB, the decimation filtering is performed followed by decimation by factor of two. In this exemplary scenario, the decimated value of the time domain samples after first stage of decimation is 15.36 MHz (step 125). Further, on the decimated time domain samples of 15.36 MHz, decimation filtering and decimation is performed in the second stage. The decimated value of the time domain samples after second stage of decimation is 7.68 MHz (step 127). Thereafter, on the decimated time domain samples of 7.68 MHz, decimation filtering and decimation is performed in the third stage. The decimated value of the time domain samples after third stage of decimation is 3.84 MHz (step 129). Finally, on the decimated time domain samples of 3.84 MHz, decimation filtering and decimation is performed in the fourth stage. The decimated value of the time domain samples after fourth stage of decimation is 1.92 MHz (step 131). Therefore, the value of the final decimated time domain samples is 1.92 MHz. Finally, at step 133, the base station 101 may extract a predefined number of tones from left and right of the center of the frequency domain sample to obtain the valid tones within the frequency domain samples. Specifically, 24 tones left of center i.e., 256 point is 233 point and 24 tones right of center i.e., 256 point is 281 point. This is an exemplary scenario for 512-point FFT.

FIG. 1C shows an exemplary flowchart illustrating method steps for performing block processing, in accordance with some embodiments of the present disclosure.

Referring to FIG. 1C, at step 131, DMRS symbols are extracted from each slot of modified PRB. The DMRS symbols are used for estimating FO. The FO will introduce linear phase offset across DMRS symbols in each slot. The FO is estimated by correlating multiple DMRS symbols in each slot (time correlation index). The DMRS symbols in NPUSCH are generated using Pseudo Random Base Sequence (PRBS). In L1 receiver algorithm, the first step is to remove the PRBS sequence which is termed as ‘dePrbs’. Removal of the PRBS sequence is done by conjugating multiplication of PRBS with the received signal. At step 133, the data symbols are extracted. Further, at step 135, the DMRS signal undergoes a process of dePrbs to remove the PRBS sequence. The dePrbs which is removed is determined using below equation:

$$dePrbs \text{=>} received signal * conjugate ( PRBS ) \qquad ( 1 )$$

At step 137, FO is estimated i.e., FO estimation is phase of correlation value between dePrbs symbols across slots. The equation below is used to estimate the FO:

$${ε}^{q} = \frac{{N}_{s}}{( 2 π {N}_{g} )} angle ( {\sum }_{s = 0}^{2 B - 1} {{C}^{Λ}}_{s} \cdot {{C}^{Λ}}_{s + D}^{*} ) \qquad ( 2 )$$

ε^{q}—slope of phase ramp estimated for each antenna q
Ns—sampling rate
Ng—sub-carrier spacing
D—time correlation index
In an embodiment, the base station 101 estimates FO using weighted moving average. According to weighted moving average, previously estimated FO is used for subsequent estimation of the FO. Weighted moving average used to estimate FO is performed as per the steps shown below:

$$phaseWeight = 1 / blockIndex \text{=>} weightage for instantaneous estimates , blockIndex = \{ 1 , 2 , … \}$$

$$phaseIns \text{=>} instantaneous phase estimated for a block$$

$$phaseInc \text{=>} phase estimated for current block by considering earlier block phase estimate and instantaneous phase estimate$$

$$phaseInc \text{=>} ( 1 - phaseWeight ) * phaseAvg + phaseWeight * phaseIns$$

$$phaseAvg = phaseInc , at the end of current block processing the average value of current block is updated .$$

Thereafter, FO averaging is performed followed by FO compensation across symbols (step 139 and 141). At step 143, channel estimation is performed. At step 145, SNR estimation is performed. At step 147, Signal to Interference Noise Ratio (SINR) is estimated using weighted moving average, wherein previously estimated SINR is used for subsequent estimation. At step 149, condition whether each slot within the block is completely processed or not is checked prior to moving to the next step. As per step 149, the condition whether 8 slots are completely processed or not is checked. Finally, the steps 151 to 161 illustrate the steps involved in equalization, demapping and decoding to decode the data. As an example, the data may be user data and control data.

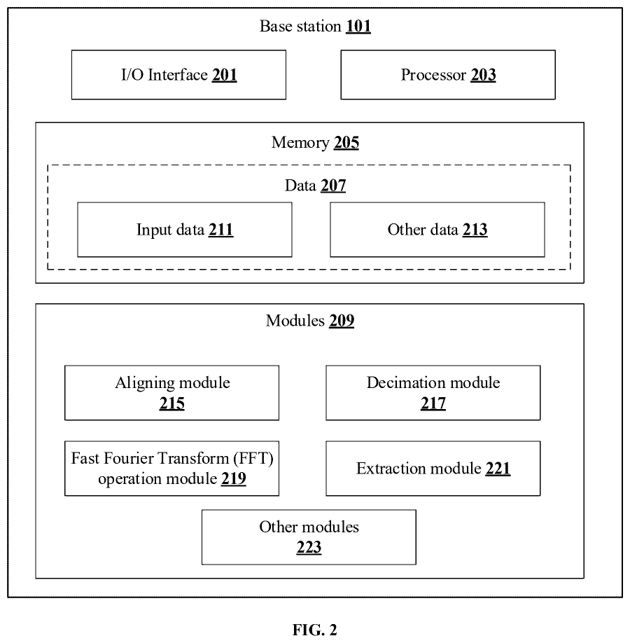

FIG. 2 shows a detailed block diagram of base station 101, in accordance with some embodiments of the present disclosure.

In some implementations, the base station 101 may include an I/O interface 201, a processor 203 and a memory 205. In an embodiment, the memory 205 may be communicatively coupled to the processor 203. The processor 203 may be configured to perform one or more functions of the base station 101 for processing of Narrow Band-Internet Of Things (NB-IoT) Physical Resource Block (PRB), using the data 207 and the one or more modules 209 of the base station 101. In an embodiment, the memory 205 may store data 207. Although the FIG. 2 shows the hardware components of the base station 101, it is to be understood that other embodiments are not limited thereon. In other embodiments, the base station 101 may include less or a greater number of components. Further, the labels or names of the components are used only for illustrative purpose and does not limit the scope. One or more components can be combined together to perform same or substantially similar technical feature for the processing of Narrow Band-Internet of Things (NB-IoT).

In an embodiment, the data 207 stored in the memory 205 may include, without limitation, input data 211 and other data 213. In some implementations, the data 207 may be stored within the memory 205 in the form of various data structures. Additionally, the data 207 may be organized using data models, such as relational or hierarchical data models. The other data 213 may include various temporary data and files generated by the one or more modules 209.

In an embodiment, the data 207 may be processed by one or more modules 209 of the base station 101. In some implementations, the one or more modules 209 may be communicatively coupled to the processor 203 for performing one or more functions of the base station 101. In an implementation, the one or more modules 209 may include, without limiting to, an aligning module 215, a decimation module 217, a Fast Fourier Transform (FFT) operation module 219, an extraction module 221 and other modules 223.

As used herein, the term module may refer to an Application Specific Integrated Circuit (ASIC), an electronic circuit, a hardware processor 203 (shared, dedicated, or group) and memory that execute one or more software or firmware programs, a combinational logic circuit, and/or other suitable components that provide the described functionality. In an implementation, each of the one or more modules 209 may be configured as stand-alone hardware computing units. In an embodiment, the other modules 223 may be used to perform various miscellaneous functionalities on the base station 101. It will be appreciated that such one or more modules 209 may be represented as a single module or a combination of different modules.

In an embodiment, the input data 211 may be a signal received using Common Public Radio Interface (CPRI) from a plurality of User Equipment's (UEs). The signal may be a Physical Resource Block (PRB) in a received time domain samples of Long-Term Evolution (LTE) bandwidth. As an example, the PRB may be a Narrow Band-Internet of Things (NB-IoT) PRB. The base station 101 may receive the plurality of uplink signals utilizing a NPUSCH Format 1/Format 2. The input data 211 is used for processing the signal received from the plurality of UEs and further used to decode the data from the PRB.

In an embodiment, the aligning module 215 of the base station 101 may be configured for aligning a center of a Physical Resource Block (PRB) in a received time domain samples of Long-Term Evolution (LTE) channel bandwidth to a center of the LTE channel bandwidth. In an embodiment, the aligning module 215 may determine phase ramp of the received time domain samples, wherein the phase value is a difference between the center of the LTE bandwidth and the center of the PRB. Further, the aligning module 215 may shift the center of the PRB by the determined phase ramp to align PRB to the center of the LTE channel bandwidth.

In an embodiment, the decimation module 217 may be configured for performing decimation on the received time domain samples at a predefined number of decimation stages sequentially to obtain a decimated time domain samples of a predefined sample rate. In an embodiment, the decimation module 217 may be configured for performing decimation filtering on the received time domain samples to obtain filtered time domain samples prior to performing decimation at each of the predefined number of decimation stages. Upon performing decimation filtering, the decimation module 217 may perform decimation on the filtered time domain samples to obtain the decimated time domain samples. The decimated time domain samples at each decimation stage of the predefined number of decimation stages is used in subsequent decimation stages of the decimation. In an embodiment, the decimation module 217 may also be configured to determine the number of decimation stages to be performed to obtain decimated time domain samples. As an example, the exemplary values to determine the decimation stages for 3.75 KHz subcarrier spacing is shown below:

TABLE A

| | | | | | |
|---|---|---|---|---|---|
| Decimation | | 2 | 3 | 4 | 5 |
| stages | | | | | |
| Decimation | | 4 | 8 | 16 | 32 |
| factor | | | | | |
| Subcarrier | 3.75 KHz | 3.75 KHz | 3.75 KHz | 3.75 KHz | 3.75 KHz |
| spacing | | | | | |
| Sample rate | 30.72 MHz | 7.68 MHz | 3.84 MHz | 1.92 MHz | 0.96 MHz |
| FFT points | 8192 | 2048 | 1024 | 512 | 256 |

As shown in the above table, by performing decimation, the sample rate of the time domain samples can be reduced while maintaining the subcarrier spacing. In case FFT size 1024 and 2048, configurable logic block requirement in FPGA will be high, indicating more HW requirement and requires more power. In case of 256-point FFT requires decimation factor of 32, i.e., 5 stages of decimation this introduces additional group delay. With these constraints 512-point FFT will be optimal for decoding 3.75 kHz.

In an embodiment, the Fast Fourier Transform (FFT) operation module 219 may be configured for performing FFT operation on the decimated time domain samples using the FFT of the predefined point to obtain corresponding frequency domain samples related to the decimated time domain samples. As an example, the 512-point FFT may be used for performing the FFT operation.

In an embodiment, the extraction module 221 may be configured for extracting valid tones from the frequency domain samples based on valid tone indices to obtain a modified PRB. The modified PRB is transmitted to a processing unit for decoding data from the modified PRB. Further, the extraction module 221 may receive one or more Resource Unit (RU) blocks from a Radio Unit (RU). The one or more RU blocks are associated with the modified PRB. Thereafter, the extraction module 221 may determine a final Frequency Offset (FO) and a final Signal to Interference Noise Ratio (SINR) of each of the one or more RU blocks by recursively performing weighted moving average FO of each of the RU blocks with FO of corresponding previous RU block, and SINR of each of the RUs with SINR of corresponding previous RU block. Finally, the extraction module 221 may decode the data from each of the one or more RU blocks using the final FO and the final SINR. In an embodiment, the extraction module 221 may be configured to perform each step discussed in FIG. 1C.

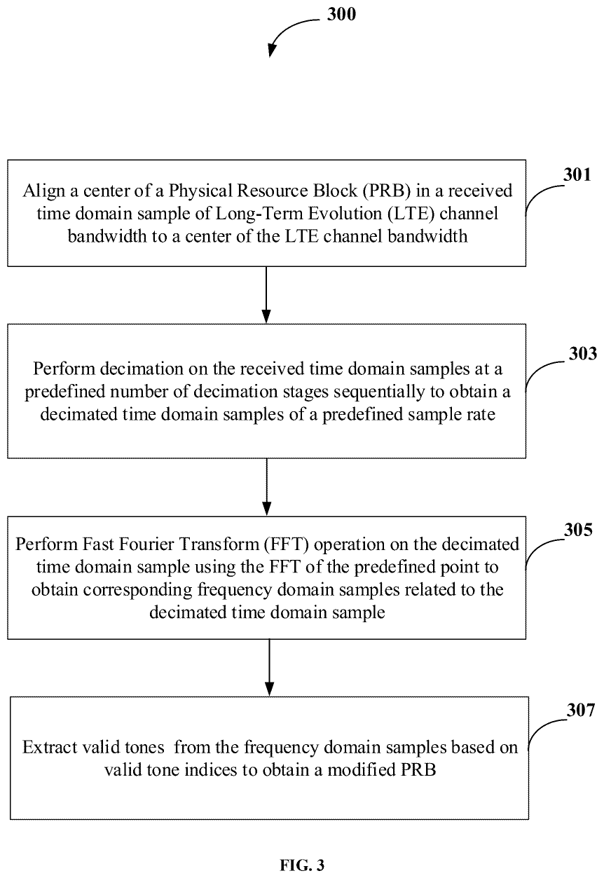

FIG. 3 illustrates exemplary flowchart illustrating method steps for processing of an exemplary Physical Resource Block (PRB) i.e., a Narrow Band-Internet of Things (NB-IoT) PRB, in accordance with some embodiments of the present disclosure.

As illustrated in FIG. 3, the method 300 may include one or more blocks illustrating a method for processing of Narrow Band-Internet of Things (NB-IoT) Physical Resource Block (PRB), in accordance with some embodiments of the present disclosure illustrated in FIG. 2. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the method 300 includes transmitting, by a processor 203 of the base station 101, aligning a center of a Physical Resource Block (PRB) in a received time domain samples of Long-Term Evolution (LTE) channel bandwidth to a center of the LTE channel bandwidth. The PRB and the modified PRB may be a Narrow Band-Internet of Things (NB-IoT) PRB. In an embodiment, to align the PRB, the processor 203 may determine phase ramp of the received time domain samples. The phase value is a difference between the center of the LTE bandwidth and the center of the PRB. Further, the processor 203 may shift the center of the PRB by the determined phase ramp to align PRB to the center of the LTE channel bandwidth.

At block 303, the method 300 includes upon aligning the center of the PRB with the center of the LTE channel bandwidth, performing, by a processor 203, decimation on the received time domain samples at a predefined number of decimation stages sequentially to obtain a decimated time domain samples of a predefined sample rate. The predefined number of decimation stages may be determined based on a predefined decimation factor. In an embodiment, for performing decimation, the processor 203 may perform decimation filtering on the received time domain samples to obtain filtered time domain samples prior to performing decimation at each of the predefined number of decimation stages. Further, the processor 203 may perform decimation on the filtered time domain samples to obtain the decimated time domain samples. The decimated time domain samples at each decimation stage of the predefined number of decimation stages is used in subsequent decimation stages of the decimation.

At block 305, the method 300 includes performing, by a processor 203, Fast Fourier Transform (FFT) operation on the decimated time domain samples using the FFT of the predefined point to obtain corresponding frequency domain samples related to the decimated time domain samples.

At block 307, the method 300 includes extracting, by a processor 203, valid tones from the frequency domain samples based on valid tone indices to obtain a modified PRB. The modified PRB is transmitted to a processing unit for decoding data from the modified PRB. In an embodiment, the processor 203 may extract a predefined number of tones from left and right of the center of the frequency domain sample to obtain the valid tones within the frequency domain samples. In an embodiment, the processor 203 may receive one or more Resource Unit (RU) blocks from a Radio Unit (RU), wherein the one or more RU blocks are associated with the modified PRB. Further, the processor 203 may determine a final Frequency Offset (FO) and a final Signal to Interference Noise Ratio (SINR) of each of the one or more RU blocks by recursively performing weighted moving average FO of each of the RU blocks with FO of corresponding previous RU block, and SINR of each of the RUs with SINR of corresponding previous RU block. Finally, the processor 203 may decode the data from each of the one or more RU blocks using the final FO and the final SINR.

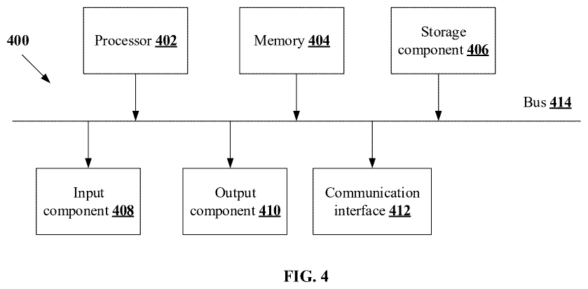

FIG. 4 illustrates an embodiment of a base station 400. As shown in FIG. 4, the base station 400 comprises a processor 402, a memory 404, a storage component 406, an input component 408, an output component 410, a communication interface 412, and a bus 414.

The processor 402, as used herein, means any type of computational circuit that may comprise hardware elements and software elements. The processor 402 may be embodied as a multi-core processor, a single core processor, or a combination of one or more multi-core processors and/or one or more single core processors, a distributed processing system, or the like. The processor 402 may be a Central Processing Unit (CPU), a graphics processing unit (GPU), an accelerated processing unit (APU), an application-specific integrated circuit (ASIC), or another type of processing component.

The memory 404 includes a non-transitory computer readable medium. Memory 404 includes a random-access memory (RAM), a read only memory (ROM), and/or another type of dynamic or static storage device (e.g., a flash memory, a magnetic memory, and/or an optical memory) that stores information and/or instructions for use by processor 402. The memory 404 comprises machine-readable instructions which are executable by the processor 402. These machine-readable instructions when executed by the processor 402 cause the processor 402 to perform one or more method steps of an embodiment described above.

The storage component 406 stores information and/or software related to the operation and use of the base station 400. For example, the storage component 406 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The input component 408 is configured to receive information, such as user input. For example, the input component 408 may include, but not be limited to, a touch screen display, a keyboard, a keypad, a mouse, a button, a switch, and/or a microphone. Additionally, or alternatively, the input component 408 may include a sensor for sensing information (e.g., a global positioning system (GPS), an accelerometer, a gyroscope, and/or an actuator).

The output component 410 is configured to provide output information from the base station 400. For example, the output component 410 may be, but not limited to, a display, a speaker, instructions to an external device, and/or one or more light-emitting diodes (LEDs).

The communication interface 412 is an interface that provides a communication connection to other devices, such as external devices and internal devices. The connection by the communication interface 412 can be a wired connection, a wireless connection, or a combination of wired and wireless connections, and can be a direct connection or an indirect connection via a communication network that exists between the base station 400 and other devices. In other words, the standard of the communication interface 412 is not limited.

The bus 414 acts as an interconnect between the processor 402, the memory 404, the storage component 406, the input component 408, the output component 410, and the communication interface 412 of the base station 400. The bus 414 may include a wired interconnection or a wireless interconnection.

The number and arrangement of components shown in FIG. 4 are provided as an example. In practice, the base station 400 may include additional components, fewer components, different components, or differently arranged components than those shown in FIG. 4. Additionally, or alternatively, a set of components (e.g., one or more components) of the base station may perform one or more functions described as being performed by another set of components of the base station. Further, one or more method steps described in any of the embodiments may be performed utilizing a plurality of the base station in communication with one another.

What is claimed is:

1. A method comprising:
aligning a center of a Physical Resource Block (PRB) in a received time domain samples of Long-Term Evolution (LTE) channel bandwidth to a center of the LTE channel bandwidth;
upon aligning the center of the PRB with the center of the LTE channel bandwidth, performing decimation on the received time domain samples at a predefined number of decimation stages sequentially to obtain a decimated time domain samples of a predefined sample rate;
performing Fast Fourier Transform (FFT) operation on the decimated time domain samples using the FFT of the predefined point to obtain corresponding frequency domain samples related to the decimated time domain samples; and
extracting valid tones from the frequency domain samples based on valid tone indices to obtain a modified PRB, wherein the modified PRB is transmitted to a processing unit for decoding the modified PRB.

2. The method as claimed in claim 1, wherein aligning the PRB comprises:
determining phase ramp of the received time domain samples, wherein the phase value is a difference between the center of the LTE bandwidth and the center of the PRB; and
shifting the center of the PRB by the determined phase ramp to align PRB to the center of the LTE channel bandwidth.

3. The method as claimed in claim 1, wherein extracting the valid tones from the frequency domain samples comprises:
extracting a predefined number of tones from left and right of the center of the frequency domain sample to obtain the valid tones within the frequency domain samples.

4. The method as claimed in claim 1, wherein the predefined number of decimation stages are determined based on a predefined decimation factor.

5. The method as claimed in claim 1, wherein performing the decimation on the received time domain samples comprises:
performing decimation filtering on the received time domain samples to obtain filtered time domain samples prior to performing decimation at each of the predefined number of decimation stages; and
performing decimation on the filtered time domain samples to obtain the decimated time domain samples, wherein the decimated time domain samples at each decimation stage of the predefined number of decimation stages is used in subsequent decimation stages of the decimation.

6. The method as claimed in claim 1, further comprises:
receiving one or more Resource Unit (RU) blocks from a Radio Unit (RU), wherein the one or more RU blocks are associated with the modified PRB;
determining a final Frequency Offset (FO) and a final Signal to Interference Noise Ratio (SINR) of each of the one or more RU blocks by recursively performing weighted moving average FO of each of the RU blocks with FO of corresponding previous RU block, and SINR of each of the RUs with SINR of corresponding previous RU block; and
decoding the data from each of the one or more RU blocks using the final FO and the final SINR.

7. The method as claimed in claim 1, wherein the PRB and the modified PRB are a Narrow Band-Internet of Things (NB-IoT) PRB.

8. A base station (101) configured to:
align a center of a Physical Resource Block (PRB) in a received time domain samples of Long-Term Evolution (LTE) channel bandwidth to a center of the LTE channel bandwidth;
upon aligning the center of the PRB with the center of the LTE channel bandwidth, perform decimation on the received time domain samples at a predefined number of decimation stages sequentially to obtain a decimated time domain samples of a predefined sample rate;
perform Fast Fourier Transform (FFT) operation on the decimated time domain samples using the FFT of the predefined point to obtain corresponding frequency domain samples related to the decimated time domain samples; and
extract valid tones from the frequency domain samples based on valid tone indices to obtain a modified PRB, wherein the modified PRB is transmitted to a processing unit for decoding the modified PRB.

9. The base station (101) as claimed in claim 8, wherein to align the PRB, the base station (101) is configured to:
determine phase ramp of the received time domain samples, wherein the phase value is a difference between the center of the LTE bandwidth and the center of the PRB; and
shift the center of the PRB by the determined phase ramp to align PRB to the center of the LTE channel bandwidth.

10. The base station (101) as claimed in claim 8, wherein to extract the valid tones from the frequency domain samples, the base station (101) is configured to:
extract a predefined number of tones from left and right of the center of the frequency domain sample to obtain the valid tones within the frequency domain samples.

11. The base station (101) as claimed in claim 8, wherein the predefined number of decimation stages are determined based on a predefined decimation factor.

12. The base station (101) as claimed in claim 8, wherein to perform the decimation on the received time domain samples, the base station (101) is configured to:
perform decimation filtering on the received time domain samples to obtain filtered time domain samples prior to performing decimation at each of the predefined number of decimation stages; and
perform decimation on the filtered time domain samples to obtain the decimated time domain samples, wherein the decimated time domain samples at each decimation stage of the predefined number of decimation stages is used in subsequent decimation stages of the decimation.

13. The base station (101) as claimed in claim 8, is further configured to:
receive one or more Resource Unit (RU) blocks from a Radio Unit (RU), wherein the one or more RU blocks are associated with the modified PRB;
determine a final Frequency Offset (FO) and a final Signal to Interference Noise Ratio (SINR) of each of the one or more RU blocks by recursively performing weighted moving average FO of each of the RU blocks with FO of corresponding previous RU block, and SINR of each of the RUs with SINR of corresponding previous RU block; and
decode the data from each of the one or more RU blocks using the final FO and the final SINR.

14. The base station (101) as claimed in claim 8, wherein the PRB and the modified PRB are a Narrow Band-Internet of Things (NB-IoT) PRB.

15. A non-transitory computer readable medium including instructions stored thereon that when processed by at least one processor, cause a computing system to perform operations comprising:
aligning a center of a Physical Resource Block (PRB) in a received time domain samples of Long-Term Evolution (LTE) channel bandwidth to a center of the LTE channel bandwidth;
upon aligning the center of the PRB with the center of the LTE channel bandwidth, performing decimation on the received time domain samples at a predefined number of decimation stages sequentially to obtain a decimated time domain samples of a predefined sample rate;
performing Fast Fourier Transform (FFT) operation on the decimated time domain samples using the FFT of the predefined point to obtain corresponding frequency domain samples related to the decimated time domain samples; and
extracting valid tones from the frequency domain samples based on valid tone indices to obtain a modified PRB, wherein the modified PRB is transmitted to a processing unit for decoding the modified PRB.

16. The non-transitory computer readable medium as claimed in claim 15, wherein aligning the PRB comprises:
determining phase ramp of the received time domain samples, wherein the phase value is a difference between the center of the LTE bandwidth and the center of the PRB; and
shifting the center of the PRB by the determined phase ramp to align PRB to the center of the LTE channel bandwidth.

17. The non-transitory computer readable medium as claimed in claim 15, wherein extracting the valid tones from the frequency domain samples comprises:
extracting a predefined number of tones from left and right of the center of the frequency domain sample to obtain the valid tones within the frequency domain samples.

18. The non-transitory computer readable medium as claimed in claim 15, wherein the predefined number of decimation stages are determined based on a predefined decimation factor.

19. The non-transitory computer readable medium as claimed in claim 15, wherein performing the decimation on the received time domain samples comprises:
performing decimation filtering on the received time domain samples to obtain filtered time domain samples prior to performing decimation at each of the predefined number of decimation stages; and
performing decimation on the filtered time domain samples to obtain the decimated time domain samples, wherein the decimated time domain samples at each decimation stage of the predefined number of decimation stages is used in subsequent decimation stages of the decimation.

20. The non-transitory computer readable medium as claimed in claim 15, wherein the operation further comprises:
receiving one or more Resource Unit (RU) blocks from a Radio Unit (RU), wherein the one or more RU blocks are associated with the modified PRB;
determining a final Frequency Offset (FO) and a final Signal to Interference Noise Ratio (SINR) of each of the one or more RU blocks by recursively performing weighted moving average FO of each of the RU blocks with FO of corresponding previous RU block, and SINR of each of the RUs with SINR of corresponding previous RU block; and
decoding the data from each of the one or more RU blocks using the final FO and the final SINR.
